(19) United States
(12) Patent Application Publication
(10) Pub. No.: US 2011/0073335 A1
(43) Pub. Date: Mar. 31, 2011

(54) POWER TOOLS

(75) Inventors: Kazuya KATO, Anjo-shi (JP); Takuji Kimura, Anjo-shi (JP); Atsushi Utsuno, Anjo-shi (JP); Kenji Abe, Anjo-shi (JP)

(73) Assignee: MAKITA CORPORATION, ANJO-SHI (JP)

(21) Appl. No.: 12/883,670

(22) Filed: Sep. 16, 2010

(30) Foreign Application Priority Data
Sep. 29, 2009 (JP) 2009-224117

(51) Int. Cl. B25F 3/00; B25F 5/02

(52) U.S. Cl. 173/29; 173/217

(57) ABSTRACT

A power tool includes a tool unit having an electric motor for driving a tool bit, and a first base and a second base each capable of being assembled with the tool unit. The tool unit and the first base can be assembled into a first tool. The tool unit and the second base can be assembled into a second tool that is different from the first tool.

This application claims priority to Japanese patent application serial number 2009-224117, the contents of which are incorporated herein by reference.

### BACKGROUND OF THE INVENTION

1. Field of the Invention

The present invention relates to power tools, such as laminate trimmers and routers used for machining workpieces.

2. Description of the Related Art

A known laminate trimmer or a known router includes a tool unit having an electric motor disposed therein. A base supports the tool unit against a workpiece and can be rest on an upper surface of the workpiece. The tool unit includes a spindle having a tool bit mounted thereto. In order to machine the workpiece, the tool unit is moved along the upper surface of the workpiece while the tool bit being pressed against a portion (e.g. an end edge) of the workpiece. Therefore, an end edge of the workpiece is cut or a groove is formed in the workpiece.

In general, a router is designed so as to be capable of being held with both hands of a user, so that the user can move the router while he or she holds the router with both hands. The router is used mainly for performing a heavy duty machining operation, such as an operation for forming a deep groove and an operation for deeply chamfering a workpiece. On the other hand, a laminate trimmer (hereinafter simply called a “trimmer”) is designed so as to be capable of being held with only one hand of a user, so that the user can move the trimmer while he or she holds the trimmer with one hand. The trimmer is used mainly for performing a right duty machining operation, such as an operation for forming a shallow groove. The router and the trimmer are common in that their tool bodies are supported by the respective bases and have electric motors disposed in the tool bodies and that they are moved along workpieces for machining the workpieces.

In general, the router and the trimmer are selectively used depending on a kind of work to be performed. However, in recent years, a tool bit has been proposed that can be used for either the router or the trimmer. In addition, for some kinds of machining works, it is not clear as to which of the router and the trimmer should be used. Therefore, it may be possible that both of the router and the trimmer can be used for a same machining work.

Various techniques relating to known routers and trimmers constructed as described above are disclosed, for example, in Japanese Laid-Open Patent Publication Nos. 2002-234001, 2005-305683 and 2006-326931.

Because the router allows a user to hold portions of the router, e.g., a pair of handles provided at a router base, with both hands, the router enables to reliably accurately perform a machining operation. On the other hand, because the trimmer allows a user to hold a part of a tool unit with one hand, the trimmer enables to easily perform a relatively simple machining operation, such as a chamfering operation of an end edge of a workpiece. Therefore, in the past, in order to selectively use a router or a trimmer depending on a kind of work to be performed, both of the router and the trimmer were carried to a workplace. This requires troublesome works and efforts for carrying the router and the trimmer to and out of the workplace. In addition, if a required work can be performed by using either the router or the trimmer, one of the router and the trimmer is not necessary while the other being used. Therefore, the router and the trimmer cannot be effectively used.

Therefore, there is a need in the art for a power tool that can be used as two or more different power tools and has a part, or a unit that can be commonly used for the different power tools.

### SUMMARY OF THE INVENTION

A power tool includes a tool unit having an electric motor for driving a tool bit, and a first base and a second base each capable of being assembled with the tool unit. The tool unit and the first base can be assembled into a first tool. The tool unit and the second base can be assembled into a second tool that is different from the first tool.

### BRIEF DESCRIPTION OF THE DRAWINGS

FIG. 1 is a perspective view of a power tool according to an example and showing a power tool and first and second bases in forms of being separated from each other;

FIG. 2 is a perspective view of the power tool assembled for use in a trimmer mode, in which the tool unit is supported on the first base; and

FIG. 3 is a perspective view of the power tool assembled for use in a router mode, in which the tool unit is supported on the second base.

### DETAILED DESCRIPTION OF THE INVENTION

Each of the additional features and teachings disclosed above and below may be utilized separately or in conjunction with other features and teachings to provide improved power tools. Representative examples of the present invention, which examples utilize many of these additional features and teachings both separately and in conjunction with one another, will now be described in detail with reference to the attached drawings. This detailed description is merely intended to teach a person of skill in the art further details for practicing preferred aspects of the present teachings and is not intended to limit the scope of the invention. Only the claims define the scope of the claimed invention. Therefore, combinations of features and steps disclosed in the following detailed description may not be necessary to practice the invention in the broadest sense, and are instead taught merely to particularly describe representative examples of the invention. Moreover, various features of the representative examples and the dependent claims may be combined in ways that are not specifically enumerated in order to provide additional useful examples of the present teachings.

In one example, a power tool includes a tool unit having an electric motor for driving a tool bit, and a first base and a second base each capable of being assembled with the tool unit for supporting the tool unit. The'power tool can be used in a trimmer mode and a router mode. In the trimmer mode, the tool unit and the first base are assembled to configure a trimmer, i.e., a laminate trimmer, (trimmer mode). At least one of the tool unit and the first base includes a grip portion sized to be capable of being grasped with one hand of a user, so that the user can hold the power tool with one hand and can move the power tool along a workpiece for machining the workpiece. In the router mode, the tool unit and the second base are assembled to configure a router (router mode). The second base has at least two handles capable of being grasped with both hands of the user, so that the user can hold the power tool with both hands and can move the power tool along a workpiece for machining the workpiece.

In the trimmer mode, a relatively light duty machining operation, such as an operation for forming a shallow groove, can be performed by moving the first power tool along the upper surface of a workpiece while a user grasps the tool unit and/or the first base with one hand.

In the router mode, a relatively heavy duty machining operation, such as an operation for forming a deep groove and a chamfering operation, can be performed by moving the second power tool along the upper surface of a workpiece while a user grasps the handles with both hands.

In this way, the power tool can be used as a trimmer by mounting the first base to the tool unit, while the power tool can be used as a router by mounting the second base to the tool unit. Thus, the power tool is convertible between a trimmer and a router.

Therefore, a user may carry the power tool including the tool unit and the first and second bases to a workplace, where the user can use the power tool as a trimmer or a router. As a result, the power tool can provide an improved usability and may be a high-value added product. In addition, because the tool unit can be used as a common component used both in the trimmer mode and the router mode, the tool unit can be effectively used with a high utilization ratio in comparison with the case where a power tool serving only as a trimmer and a power tool serving only as a router are carried to a workplace and are selectively used.

Preferably, the power tool may be stored into a single storage box, so that a portability and a handling property can be improved, enabling to further effectively perform a machining operation.

In general, for the first base used in the trimmer mode, it only requires a function for supporting the tool unit and a function for guiding on a workpiece. Therefore, the first base may have a relatively simple construction and may be relatively lightweight. On the other hand, the second base has the handles and may have a lift function for moving the tool unit up and down in addition to the functions required for the first base. Therefore, the second base may be relatively heavyweight.

The total weight of the first power tool may be less than 2 kg. Because a conventional trimmer has a weight of less than about 2 kg, the first power tool can be used by being grasped with one hand in the same manner as the conventional trimmer. Therefore, a light duty machining operation can be easily effectively performed.

The grip portion of the first power tool may have a circumferential length of between 188 mm (60π mm) and 314 mm (100π mm). With this determination of size of the grip portion, a user can easily grasp the grip portion for performing a light duty machining operation.

It has been known to the inventors that an inner circumferential length of a loop formed by a forefinger and a thumb of a hand of a human may be used as a reference for determining a thickness of a grip portion of a product. The inventors obtained the following data about inner diameters of the loops of hands of peoples within an age range capable of using power tools in several countries:
British: 35 mm-47 mm (males); 33 mm-44 mm (females)
Netherlander: 36 mm-48 mm (males); 34 mm-45 mm (females)
American: 35 mm-47 mm (males); 32 mm-44 mm (females)
Japanese: 34 mm 46 mm (males); 33 mm-43 mm (females)

According to the above data, the minimum value and the maximum value of the inner diameter of the loop of hand are 32 mm and 48 mm, respectively. Therefore, it may be preferably that the size of the grip portion is determined on the basis of the range of between about 30 mm and 50 mm of the inner diameter of the loop of hand. On the other hand, in order that the grip portion is reliably held, the fingers are necessary to be applied to extend over substantially half the circumferential length of the grip portion. Hence, by setting the diameter of the grip portion to 60 mm to 100 mm or setting the circumferential length of the grip portion to 188 mm (60π mm) to 314 mm (100π mm), a majority of peoples who will use power tools can reliably grasp the grip portion of the power tool in the trimmer mode. This preferable circumferential length of 188 mm to 314 mm may also be applied to a grip portion that has an oblong cross section, a polygonal cross section or any other cross section other than a circular cross section.

In the ease that the tool unit has a cylindrical configuration and that the support portion of the first base also has a cylindrical configuration and is used as the grip portion (having the circumferential length of between 188 mm (60π mm) and 314 mm (100π mm), the circumferential length of the tool unit may be set within a range of between 170 mm (54π mm) and 295 mm (94π mm) assuming that the support portion has a thickness of 3 mm.

Setting the tool unit to have a circumferential length of between 173 mm (55π mm) and 298 mm (95π mm) enables the tool unit to be used in combination with either the first base or the second base. This preferable circumferential length of between 173 mm and 298 mm can also be applied to a tool unit that has an oblong cross section, a polygonal cross section or any other cross section other than a circular cross section.

The tool unit may include a case for receiving therein the motor, and a spindle rotatably driven by the motor. The tool bit can be mounted to the spindle.

The first base may have a first support portion for receiving the case and have a fixing device releasably fixing the first support portion to the case. The first support portion has a tubular configuration with an open upper end, so that the ease of the tool unit can be inserted into the first support portion via the open upper end. The first support portion includes a stepped portion formed on an inner wall of the first support portion for engaging a part of the case, so that movement of the case in an inserting direction can be limited by the stepped portion. In one example, the first support portion is resiliently deformable, and the fixing device can urge the first support portion to be resiliently deformed for clamping the case by the first support portion. The first base may further include a first base body and the first support portion may be mounted to the first base body.

The second base may have a second support portion for receiving the case, and a second support base vertically movably supporting the support portion. The second support portion has a tubular configuration with an open upper end, so that the case of the tool unit can be inserted into the second support portion via the open upper end. The second support portion includes a stepped portion formed on an inner wall of the second support portion for engaging a part of the case, so that movement of the case in an inserting direction can be limited by the stepped portion. The power tool set may further include a stopper device capable of stopping the movement of the second support portion in a direction toward the support base at any of a plurality of given stop positions. An adjusting device may be provided for finely adjusting the given stop positions.

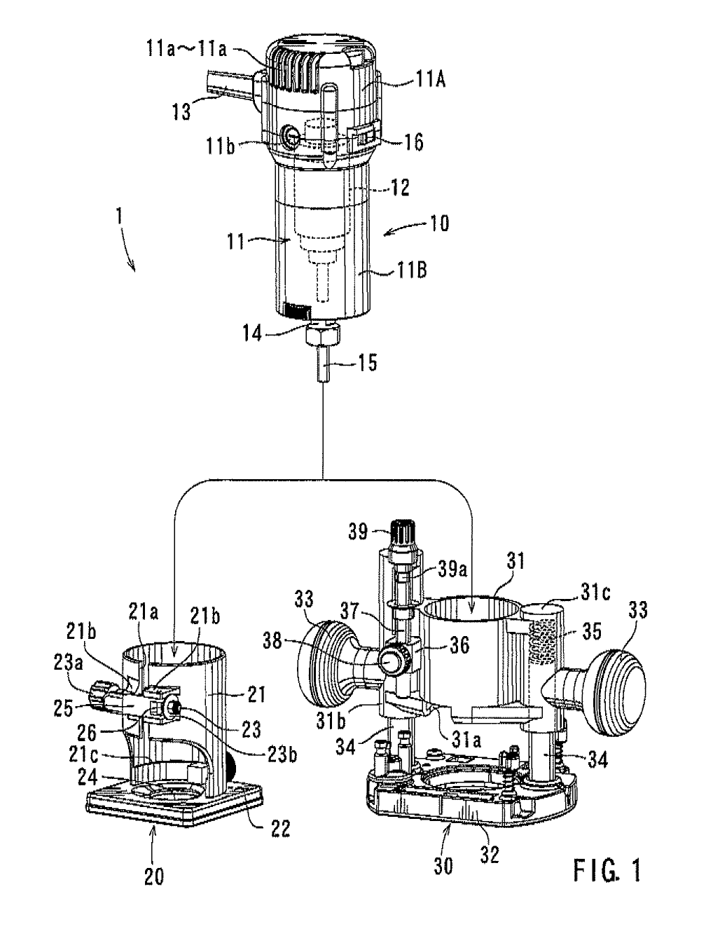

A representative example will now be described with reference to FIGS. 1 to 3. Referring to FIG. 1, a power tool 1 is designed such that it can be used as a router and also as a trimmer, i.e., a laminate trimmer. The power tool 1 has a tool unit 10, a first base 20 and a second base 30. The tool unit 10 has a case 11 made of right-weight material, such as plastic and aluminum. An electric motor 12 is disposed within the case 11 and serves as a drive source. The case 11 includes an upper case 11A and a lower case 11B. The lower case 11B may have a cylindrical configuration and has an outer diameter that allows a user to grasp the lower case 11B with his or her one hand. Preferably, the outer diameter of the lower case 11B is about 65 mm, so that the case 11B has a circumferential length of about 204 mm (65π mm). Here “π” is a circular constant.

A plurality of windows 11a are formed in the upper case 11A for introducing a cooling air into case 11. Caps 11b (only one cap 11b is shown in the drawings) are fitted into retaining holes formed in a lateral side of the upper case 11A at positions opposite to each other. The retaining holes are used for exchanging carbon brushes (not shown). A power source cord 13 is led into the upper case 11A and used for supplying an AC power to the electric motor 12. A slide-type switch 16 is mounted to the lateral side of the upper case 11A and can be operated for starting and stopping the electric motor 12.

A spindle 14 protrudes downward from a bottom of the lower case 11B. A tool bit 15 is mounted to the spindle 14. Tool bits having various configurations can be selectively used as the tool bit depending a machining work to be performed. When the slide switch 16 is turned on, the electric motor 12 starts to rotate the spindle 14, and the tool bit 15 rotates together with the spindle 14. For example, pressing the rotating tool bit 15 against an end edge of a workplace can perform a chamfering operation.

One of the first base 20 and the second base 30 can be selectively mounted to the tool unit 10. In FIG. 1, the first base 20 is shown on the left side and the second base 30 is shown on the right side. In this example, the first base 20 can be used for enabling a trimmer mode and the second base 30 can be used for enabling a router mode as will be explained later.

The first base 20 has a cylindrical support portion 21 and a base body 22. The support portion 21 has an inner diameter allowing insertion of the lower case 11B of the tool unit 10 into the support portion 21. The base body 22 can be placed on an upper surface of a workpiece. The support portion 21 has a slit 21a extending in an axial direction of the support portion 21, so that the support portion 21 is interrupted by the slit 21a at a portion along its circumferential length. Therefore, resiliency in the circumferential direction is given to the support portion 21. Projections 21b are formed on opposite circumferential ends of the support portion 21 separated by the slit 21a and are opposed to each other. A joint rod 23 is inserted into the projections 21b and can move in its axial direction relative to the projections 21b. A grip 23a is mounted to one end of the joint rod 23, so that a user can manually rotate the joint rod 23 by grasping the grip 23a. A flange 23b is mounted to the other end of the joint rod 23 and serves to restrict the axial movement of the joint rod 23.

A clamp lever 25 is laterally pivotally mounted to one of the projections 21b positioned on the right side as viewed in FIG. 1. In the state shown in FIG. 1, the clamp lever 25 is positioned at a clamp position, where the clamp lever 25 extends substantially parallel to the joint rod 23. In the clamp position, a cam (not shown) formed on the base end portion (the end portion on the side of the projection 21b to which the clamp lever 25 is mounted) of the clamp lever 25 acts on the flange 23b, to urge it rightward as viewed in FIG. 1, so that the distance between the projections 21b is decreased. Therefore, the support portion 21 is tightened to cause decrease in its diameter, and hence, the tool unit 10 (more specifically, the lower case 11B) is fixed in position relative to the support portion 21. In this example, the thickness in the diametrical direction of the support portion 21 is chosen such that the support portion 21 has a circumferential length of about 220 mm (70 π mm) in the fixing state of the tool unit 10 in order to enable a user to easily grasp the support portion 21.

When the clamp lever 25 is pivoted forwardly from the clamp position to an unclamp position, the rightward urging force applied to the flange portion 23b by the cam of the clamp lever 25 is decreased or released, so that the distance between the projections 21b is increased because the support portion 21 resiliently recovers its shape to increase the diameter. Hence, the tool unit 10 can be removed upward from the support portion 21. In other words, the support portion 21 can be removed from the tool unit 10. In this way, the tool unit 10 can be mounted to and removed from the support portion 21 by simply laterally pivoting the clamp lever 25 that is mounted to the support portion 21.

At a lower portion of an inner circumferential wall of the support portion 21, a stepped portion 21c is formed to define a limit of downward movement of the tool unit 10 relative to the support portion 21. Thus, as the tool unit 10 moves downwardly into the support portion 21c, the lower end portion of the tool unit 10 (more specifically, the lower end of the lower case 11B) abuts to the stepped portion 21c, so that the tool unit 10 cannot move further downward.

The support portion 21 is fixedly attached to a substantially central portion of an upper surface of the base body 22 that has a substantially square configuration. A circular opening 24 is formed in the central portion of the upper surface of the base body 22 at a position radially inwardly of the support portion 21, so that the tool bit 15 can extend downwardly through the circular opening 24. The lower end of the support portion 21 is fixedly attached to the upper surface of the base body 22 and has a circumferential length corresponding to substantially half the circumferential length of the circular opening 24.

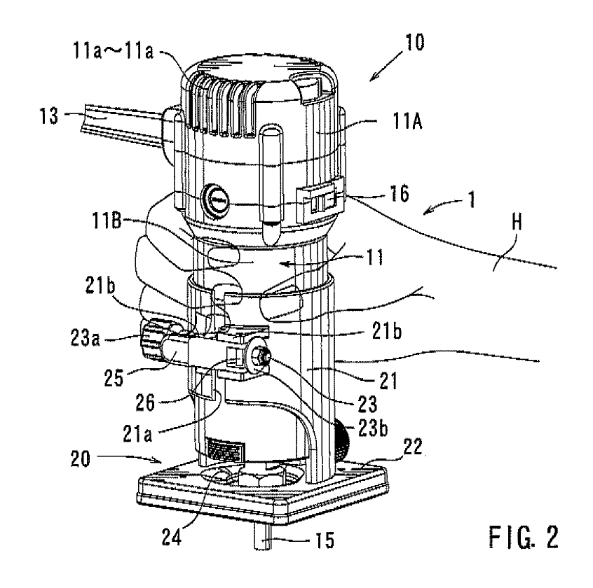

FIG. 2 shows the tool unit 10 and the first base 20 of the power tool 1, which are assembled together for use as a trimmer. In other words, the power tool 1 is prepared for use in a trimmer mode. The power tool set 1 in the trimmer mode can be held by one hand H of a user when the user intends to move the entire first power tool. More specifically, the user can grasp the support member 21 of the first base 20 and/or the case 11B of the tool unit 10 with one hand H. Therefore, the user can easily rapidly perform a machining operation, such as a chamfering operation, by the rotating tool bit 15.

The trimmer mode can be changed to a router mode for using the power tool 1 as a router by the following operations. First, the user pivots the clamp lever 25 forwardly from the clamp position to the unclamp position, so that the tool unit 10 can be easily removed from the first base 20. Then, the user mounts the tool unit 10 to the second base 30 in place of the first base 20, so that the mode of the power tool 1 is changed to the router mode.

The second base 30 has a support member 31, a base body 32, a pair of right and left handles 33, and a pair of right and left vertically movable shafts 34. The second base 30 is configured such that a user can vertically move the tool unit 10 when starting a machining operation and when finishing the machining operation. This type of base is called “plunge type base.”

Similar to the support member 21 of the first base 20, the support member 31 has an inner diameter allowing insertion of the tool unit 10 (more specifically, the lower case 11B) into the support portion 31. In addition, at a lower portion of an inner circumferential wall of the support portion 31, a stepped portion 31a is formed to define a limit of downward movement of the tool unit 10 relative to the support portion 31. Thus, when the tool unit 10 is inserted into the support member 31 from above, the lower end of the lower case 11B of the tool unit 10 abuts to the stepped portion 31a, so that the tool unit 10 is held in a position where the spindle 14 and the tool bit 15 extend downward from the support member 31. The tool unit 10 may be fixed in position relative to the support member 31 by using a suitable fixing device, such as a clamp lever and a fixing screw(s). The tool unit 10 can be removed upwardly from the support member 31 by releasing the fixing device.

Right and left support tubes 31b and 31c are formed integrally with the right side and the left side of the support member 31. Both of the support tubes 31b and 31c have lower open ends. The vertically movable shafts 34 are slidably movably inserted into the support tubes 31b and 31c, respectively. The vertically movable shafts 34 extend parallel to each other. The vertically movable shafts 34 have lower ends fixedly mounted to right and left portions of the upper surface of the base body 32, so that the vertically movable shafts 34 extend vertically upwardly from the upper surface of the base body 32. With the aid of the vertically movable shafts 34, the support member 31 can make parallel shifting movement in the vertical direction. A compression spring 35 is disposed within each of the support tubes 31b and 31c and is interposed between an upper closed end of each of the support tubes 31b and 31c and the upper end of the corresponding vertically movable shaft 34. Therefore, the support member 31 and eventually the tool unit 10 are normally biased upward by the compression springs 35.

The tool bit 15 can protrude downwardly from the lower surface of the base body 32 when the tool unit 10 is pressed downward against the biasing forces of the compression springs 35. The protruding distance of the tool bit 15 from the lower surface of the base body 32 corresponds to a cutting depth (or a grooving depth) into a workpiece by the tool bit 15. The cutting depth can be finely adjusted by using a stopper rod 37. A holder block 36 is formed integrally with a lateral surface of the left support tube 31b and vertically movably supports the stopper rod 37. The vertical position of the stopper rod 37 relative to the holder block 36 can be fixed by a manually rotatable fixing screw 38. A plurality of stopper bolts 40 (three stopper bolts 40 are provided in this example) are threadably engaged with corresponding bolt receiving portions formed on a stopper base 41 that is rotatably mounted to the upper surface of the base body 32, so that the stopper bolts 40 extend vertically upward from the stopper base 41. By rotating the stopper base 41, any one of the stopper bolts 40 can be positioned to vertically oppose to the stopper rod 37. Therefore, when the tool unit 10 is moved downward, the stopper rod 37 abuts to a head of one of the stopper bolts 40 to prevent further downward movement of the tool unit 10. Hence, the stopper rod 37 and the stopper bolts 40 define the lower moving limit of the tool unit 10 and eventually the protruding distance of tool bit 15 from the lower surface of the base body 32, which corresponds to the cutting or grooving depth into a workpiece. In this example, the stopper bolts 40 are positioned such that their heads are positioned at different heights from each other. Therefore, the lower moving limit of the tool unit 10 can be easily set to any of three different positions by rotating the stopper base 41.

In addition, the vertical position of the stopper rod 37 relative to the holder block 36 can be finely adjusted by using an adjustment dial 39. The adjustment dial 39 has a threaded shaft 39a formed integrally with the adjustment dial 39 and engaged with a corresponding threaded hole formed axially in the upper end of the stopper rod 37. In this example, the adjustment dial 39 is supported by the holder block 36 such that the adjustment dial 39 can rotate relative to the holder block 37 but cannot move in the vertical direction (axial direction of the adjustment dial 39). On the other hand, the stopper rod 37 is supported by the holder block 36 such that the stopper rod 37 can move in the vertical direction but cannot rotate relative to the holder block 36. Therefore, as the adjustment dial 39 rotates, the stopper rod 37 moves in the vertical direction due to change of engaging depth of the threaded shaft 39a into the threaded hole of the stopper rod 37.

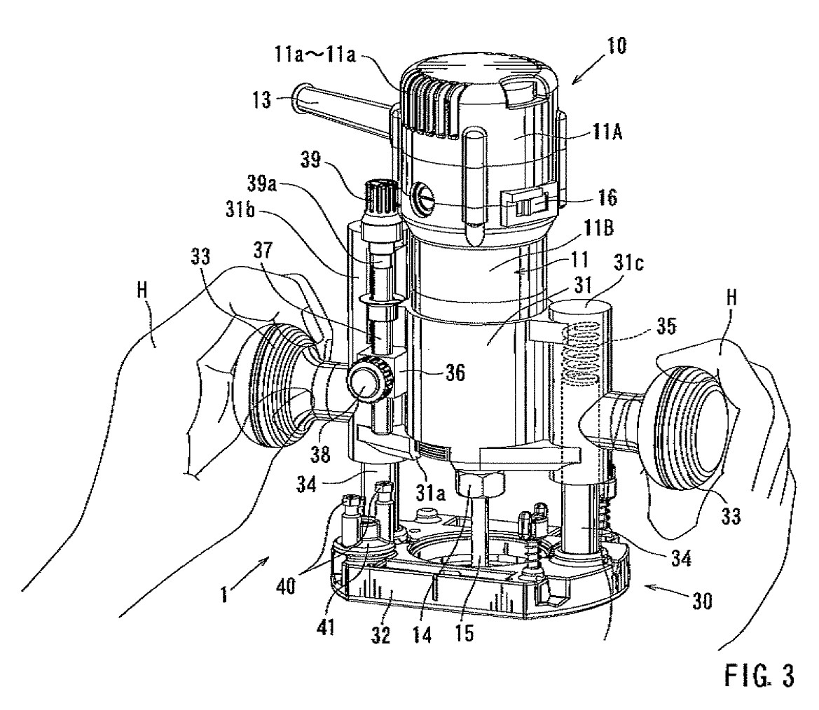

The right and left handles 33 extend laterally horizontally from the right and left support tubes 31b and 31c, respectively. Each of the handles 33 is covered with an elastomeric resin layer that can provide a slip-preventing function and an excellent gripping feel. As shown in FIG. 3, a user can grasp the handles 33 with both hands H for carrying the power tool 1 in the router mode into a workplace or for carrying the power tool 1 from the workplace into a storage place. In addition, a user can grasp the handles 33 with both hands H for pressing the tool unit 10 downward, so that the tool bit 15 protrudes downward from the lower surface of the base body 32. In this state, the user moves the power tool 1 along the upper surface of a workpiece for performing a heavy duty machining operation, such as a grooving operation for forming a deep groove and a chamfering operation

After completion of the machining operation, the user releases the pressing force applied to the tool unit 10, so that the tool unit 10 returns upward by the biasing forces of the compression springs 35. Therefore, the tool bit 15 moves upward above the lower surface of the base body 32.

According to the power tool set 1 of this example, the first base 20 and the second base 30 can be selectively mounted to the same tool unit 10, so that the power tool 1 can be used as a trimmer for a light duty machining operation or a router for a heavy duty machining operation. For example, by storing the first and second bases 20 and 30 into a storage box as a set of bases, it is possible to easily handle the first and second bases 20 and 30 for carrying them into and out of a workplace. It is also possible to store the tool unit 10 and the first and second bases 20 and 30 into a storage box.

In addition, because the tool unit 10 can be commonly used for the trimmer mode and the router mode, the rate of utilization (frequency of utilization) of the tool unit 10 can be increased. Further, the cost for manufacturing the power tool 1 is low in comparison with the costs for manufacturing a trimmer and a router that have their own tool units.

in the case that the tool unit 10 is used in the router mode, where the tool unit 10 is mounted to the second base 30, the total weight of the second power tool may be about 2 kg to about 6 kg that may be two or three times the total weight of the first power tool used in the trimmer mode. However, in the router mode, the user can reliably hold the second power tool by grasping the right and left handles 33 with both hands H and can easily move the second power tool for performing a machining operation, such as a grooving operation. Thus, the router mode allows the user to move the second power tool by grasping the second power tool with both hands H and is different from the trimmer mode where the user normally grasps the first power tool with only one hand H.

As described previously, the second base 30 used in the router mode is provided with the right and left handles 33 and is different from the first base 20 used in the trimmer mode and having no particularly provided handle.

As described previously, the total weight of the power tool 1 in the router mode is relatively high (e.g., about 2 kg to about 6 kg), and for this reason, the power tool can be firmly grasped with both hands H of the user and can be easily moved for accurately performing a heavy duty machining operation, such as an operation for forming a relatively deep groove and a chamfering operation. On the other hand, the total weight of the power tool 1 in the trimmer mode is relatively low (e.g., about 1 kg to about 2 kg), and therefore, the user can easily move the power tool 1 for performing a light duty machining operation, such as an operation for forming a relatively shallow groove, by grasping the power tool 1 with only one hand. Therefore, the power tool 1 can be used for different applications in the router mode and the trimmer mode. However, the power tool 1 in the router mode and the power tool 1 in the trimmer mode can be used for the same application in some cases, for example for a middle duty machining operation between a heavy duty machining operation and a light duty machining operation. In other words, the applicable range in the router mode and that in the trimmer mode partially overlap with each other.

Because the power tool 1 of this example having the tool unit 10 and the first and second bases 20 and 30 as one set can be used as a trimmer and also as a router, the power tool 1 can be used for a wide range of applications including a heavy duty machining operation and a light duty machining operation without need of using two separate power tools.

The total weight of the power tool 1 in the trimmer mode is preferably less than about 2 kg, more preferably between about 1 kg and about 2 kg. On the other hand, the total weight of the power tool 1 in the router mode is preferably between about 2 kg and 6 kg. These settings of the different total weights of the power tool 1 according to the different modes can be achieved by suitably setting the weights of the first base 20 and the second base 30.

The above example can be modified in various ways. For example, although the second base 30 used in the router mode is configured as a plunge type base, the second base 30 may be a fixed type base. In such a case, the tool unit 10 is fixed in position relative to the base body 32, and therefore, no downwardly pressing operation of the tool unit 10 is required for performing a machining operation. It is also possible that both of a plunge type base and a fixed type base are provided for use in the router mode.

Further, in the above example, the case 11B of the tool unit 10 has a cylindrical tubular configuration, and the support portions 21 and 31 are configured to have cylindrical tubular configurations to correspond to the configuration of the case 11B. However, the case 11B may have a polygonal tubular configuration and the support portions 21 and 31 may have a corresponding polygonal tubular configuration.

In the above example, for ease of handling of the power tool 1 in the trimmer mode, the case 11B that is a portion where the tool unit 10 is held by the support portion 21 or 31, is set to have a circumferential length of about 204 mm (65π mm) and has an outer diameter of 65 mm. However, the circumferential length may be any of the length within, a range of between 173 mm (55π mm) and 298 mm (95π mm). In other words, the outer diameter may be any of values within a range of between 55 mm and 95 mm. By setting the circumferential length or the outer diameter within the above range, it is possible to ensure that the user can easily grasp the tool unit 10.

In the trimmer mode, the user may grasp the support portion 31 in addition to the lower case 11B of the tool unit 10 or may grasp only the support portion 21 of the first base 20. Therefore, the circumferential length of the support portion 21 may be within a range between 188 mm (60π mm) and 314 mm (100π mm) (corresponding to the outer diameter within a range of 60 mm and 100 mm) in order to enable the user to easily grasp the support portion 31.

Further, although the right and left handles 33 of the second base 30 have the same configuration in the above example, the handles 33 may have different configurations from each other. Further more, three or more handles 33 can be provided.

What is claimed is:

1. A power tool comprising:
a tool unit having an electric motor for driving a tool bit; and
a first base and a second base each capable of being assembled with the tool unit for supporting the tool unit, wherein:
the power tool can be used in a trimmer mode and a router mode;
in the trimmer mode, the tool unit and the first base are assembled together for use as a trimmer;
at least one of the tool unit and the first base of the power tool in the trimmer mode includes a grip portion sized to be capable of being grasped with one hand of a user, so that the user can hold the power tool with one hand and can move the power tool along a workpiece for machining the workpiece;
in the router mode, the tool unit and the second base are assembled together for use as a router,
wherein the second base has at least two handles capable of being grasped with both hands of the user, so that the user can hold the power tool in the router mode with both hands and can move the power tool along a workpiece for machining the workpiece.

2. The power tool as in claim 1, wherein the total weight of the power tool in the trimmer mode is less than 2 kg.

3. The power tool as in claim 1, wherein the grip portion of the power tool in the trimmer mode has a circumferential length of between 188 mm and 314 mm.

4. The power tool as in claim 1, wherein the tool unit has a circumferential length of between 173 mm and 298 mm.

5. The power tool as in claim 1, wherein the tool unit includes:
a case for receiving therein the motor; and
a spindle rotatably driven by the motor;
wherein the tool bit can be mounted to the spindle.

6. The power tool as in claim 5, wherein:
the first base has a first support portion for receiving the case and has a fixing device releasably fixing the first support portion to the case.

7. The power tool as in claim 6, wherein:
the first support portion has a tubular configuration with an open upper end, so that the case of the tool unit can be inserted into the first support portion via the open upper end, and
the first support portion includes a stepped portion formed on an inner wall of the first support portion for engaging a part of the case, so that movement of the case in an inserting direction can be limited by the stepped portion.

8. The power tool as in claim 7, wherein:
the first support portion is resiliently deformable;
the fixing device can urge the first support portion to be resiliently deformed for clamping the case by the first support portion.

9. The power tool as in claim 7, wherein the first base further includes a first base body and the first support portion is mounted to the first base body.

10. The power tool as in claim 5, wherein the second base includes:
a second support portion for receiving the case; and
a second support base vertically movably supporting the second support portion.

11. The power tool as in claim 10, wherein:
the second support portion has a tubular configuration with an open upper end, so that the case of the tool unit can be inserted into the second support portion via the open upper end, and
the second support portion includes a stepped portion formed on an inner wall of the second support portion for engaging a part of the case, so that movement of the case in an inserting direction can be limited by the stepped portion.

12. The power tool as in claim 10, further including a stopper device capable of stopping the movement of the second support portion in a direction toward the support base at any of a plurality of given stop positions.

13. The power tool as in claim 12, further comprising an adjusting device capable of finely adjusting the given stop positions.

14. A power tool comprising:
a tool unit having an electric motor for driving a tool bit, and
a first base and a second base each capable of being assembled with the tool unit, wherein:
the tool unit and the first base can be assembled into a first tool; and
the tool unit and the second base can be assembled into a second tool that is different from the first tool.

15. The power tool as in claim 14, wherein the first tool serves as a trimmer and the second tool serves as a router.

16. The power tool as in claim 15, wherein:
the first tool has a grip portion capable of being grasped with one hand of a user; and
the second tool has at least two handles capable of being grasped with both hands of a user.

17. The power tool in claim 16, wherein the grip portion is defined by at least one of the tool unit and the first base.

18. The power tool as in claim 16, wherein the second base includes the handles.
